(19) United States
(12) Patent Application Publication
(10) Pub. No.: US 2026/0370697 A1
(43) Pub. Date: Nov. 19, 2026

(54) ENHANCED COMMUNICATIONS USING LOW BANDWIDTH NON-TERRESTRIAL LINKS

(71) Applicant: T-MOBILE INNOVATION LLC, Overland Park, KS (US)

(72) Inventors: Deepak JAISWAL, Redmond, WA (US); Jason Wayne Hayes, Lynnwood, WA (US)

(21) Appl. No.: 19/209,963

(22) Filed: May 16, 2025

(51) Int. Cl. H04L 65/1069; H04L 65/65; H04L 65/752

(52) U.S. Cl. CPC H04L 65/1069; H04L 65/65; H04L 65/752

(57) ABSTRACT

At a high level, the technology disclosed herein relates to enhancing communications (e.g., refining voice calls) over low bandwidth non-terrestrial links (e.g., satellite links). In embodiments, a request for a voice call between a first user device and a second user device is received. In embodiments, the first user device may be connected with a low bandwidth satellite link and the second user device may be connected with a terrestrial network. A session descriptor of the request may be modified (e.g., from media type text to media type audio, or from media type audio to media type text), and the voice call may be initiated based on this modification.

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for enhancing communications (e.g., refining voice calls) over low bandwidth non-terrestrial links (e.g., satellite links) by particular techniques that include transforming speech to text, and vice versa, for seamless communication without a location barrier. Embodiments herein include a whisper engine (e.g., a mobile over-the-top (OTT) communication platform) that provides for various data communications over lower bandwidth non-terrestrial communications (e.g., Extremely Low Bandwidth Satellite Communications (ELB-SC)) by providing text to a terrestrial network (e.g., core network) for terrestrial protocol integration and enhanced communication. The whisper engine may be communicatively coupled to a whisper application installed on user equipment (e.g., and originator and terminator), terrestrial networks, and/or non-terrestrial networks for providing communications over ELB-SC or other low bandwidths.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example whisper engine environment having an originator device communicatively coupled with the whisper engine, in accordance with embodiments herein;

FIG. 2 depicts an example whisper engine environment having a terminator device communicatively coupled with the whisper engine, in accordance with embodiments herein;

FIG. 3 depicts an example flowchart of the functionality associated with the present technology, in accordance with embodiments herein; and

FIG. 4 depicts an example user device and example user device functionality for implementation of the present technology, in accordance with embodiments herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale, and which are not to be construed as limiting. Indeed, the present invention may be embodied in many different forms and should not be construed as limited to the aspects set forth herein.

### Definitions

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components may store data momentarily, temporarily, or permanently.

“Computer storage media” does not comprise signals per se.

For purposes of this disclosure, the word “including” or “having” has the same broad meaning as the word “comprising.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The phrase “one or more combinations thereof” may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

The term “voice call,” as used herein, may refer to a bidirectional communication between two or more user devices in which at least one user device presents audio to a user of the at least one user device.

### Technological Overview

By way of background, user device communications over low bandwidth, such as over a satellite link (e.g., ultra-low bandwidth satellite links or ELB-SC corresponding to a few hundred bits per second (bps) up to around 100 kilobits per second (kbps), a few kbps, 1 kbps, etc.), may be unreliable with respect to effectiveness, reliability, and general communication performance. Because the available data rate between devices using these types of bandwidths is constrained, there are limited types and amounts of information that may be exchanged between devices. For example, user devices utilizing low bandwidth satellite links are generally limited to communications having small amounts of data (often in the range of a few kilobits per second or less), making the transmission of large files, high-resolution images, or other types of bulkier data slow or impossible.

As another example, satellite network communications, such as over geostationary or low Earth orbit (LEO) systems, may introduce significant latency because of the long distances between user devices and the LEO, as well as from the satellite to a ground station. As a result, voice calls or live video streaming are often not manageable over ultra-low bandwidth links based on the high delays and packet loss. In yet another example, this limited bandwidth, and these longer distances pose various potential interferences (e.g., weather conditions, signal degradation, atmospheric interference, etc.), which can result in high packet loss or higher error rates. The increased packet loss and error rates can further result in retransmissions, which further consumes more bandwidth, thereby increasing the delay. As a result, user devices may fail entirely to exchange data, which is problematic for applications requiring higher reliability (e.g., emergency communications).

As another example, many protocols (e.g., protocols designed for various Internet connections, protocols that require a lot of overhead (e.g., Transmission Control Protocol (TCP), protocols that require frequent handshakes or acknowledgments, etc.) are generally not optimized for these low-bandwidth environments. To illustrate, video conferencing features, file-sharing communications, cloud storage, real-time video communication, or interactive media, high-quality streaming, etc. are each designed to manage large amounts of data and are not optimized for low or ultra-low bandwidth environments and will generally not function under these conditions.

Traditional uses of low bandwidth satellite communication links include internet of things devices transmitting GPS coordinates, a deep-space probe transmitting basic status information back to Earth, small location data transmissions, a rover on Mars transmitting small data about its location or a sensor reading back to Earth, L-band ultra-low bandwidth communications of small amounts of data, narrowband communication systems specifically designed for low data rates with specialized protocols to transmit minimal amounts of data, etc.

The present technology improves upon these technological problems associated with low bandwidth communications. For example, the methods, systems, media, techniques, etc., provided include improvements to facilitate various communications over lower bandwidth non-terrestrial links, such as providing for voice communications, that have not been previously implemented. For example, a whisper engine (e.g., a mobile over-the-top communication platform) enables voice calling over extremely low bandwidth satellite connections by receiving text (e.g., text or text inputs) from a first user device, converting the text to synthetic audio (e.g., synthetic speech), and communicating the synthetic audio to a second user device. The second user device may communicate audio inputs to the whisper engine (e.g., speaking into their user device), which converts the audio inputs to converted text, and communicates the converted text to the first user device. The whisper engine may receive textual inputs, audio inputs, or it can receive text locally converted from audio inputs. A whisper application (e.g., an over-the-top (OTT) application) installed on one or more of the user devices may cause one or more user devices (e.g., originator user devices, terminator user devices) to either display the received data as converted text or as synthetic audio (e.g., received text is locally converted to synthetic audio). The whisper engine may also include text-to-speech capabilities for transforming text received from a device connected with a low-bandwidth link into voice packets, which may be transmitted to a user device engaging in a conventional voice call.

In an embodiment, a method comprises receiving a request for a voice call between a first user device and a second user device. The method may also comprise determining that the first user device is connected with a low bandwidth link. The method may also comprise modifying a session descriptor within the request based on determining that the first user device is connected with the low bandwidth link to generate a modified session descriptor. The method may also comprise initiating the voice call between the first user device connected with the low bandwidth link and the second user device based on transmitting the modified session descriptor.

In another example embodiment, one or more computer storage media is provided. The media has computer-executable instructions embodied thereon, that when executed by at least one processor, cause the at least one processor to perform a method. The method comprises receiving a request for a voice call between the first user device and a second user device. The method may also comprise determining that the first user device is connected with a low bandwidth satellite link. The method may also comprise initiating the voice call between the first user device connected with the low bandwidth satellite link and the second user device by initiating a two-way path, a first path of the two-way path being text-based (e.g., RTP text path, text sent via data channel) with the first user device and a second path of the two-way path being voice-based (e.g., RTP audio path) with the second user device.

In another example embodiment, a system is provided. The system comprises at least one processor and computer storage media having computer-executable instructions embodied thereon, that when executed by the at least one processor, cause the at least one processor to perform operations. The operations may include receiving a request for a voice call between a first user device and a second user device. The operations may also include determining that the first user device is connected with a low bandwidth satellite link and that the second user device is connected with a terrestrial network. The operations may also include modifying a session descriptor within the request to generate a modified session descriptor based on determining that the first user device is connected with the low bandwidth satellite link and that the second user device is connected with the terrestrial network. The operations may also include transmitting the modified session descriptor and initiating the voice call between the first user device and the second user device based on transmitting the modified session descriptor.

### Example Operating Environments

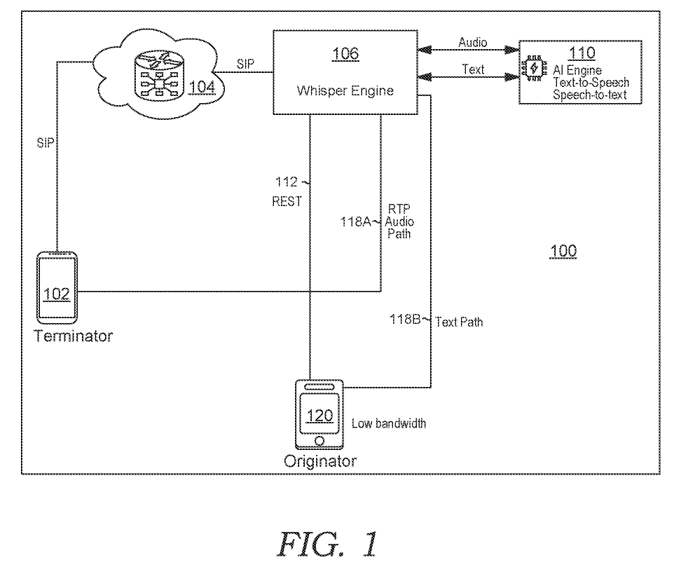

FIG. 1 includes an example computing environment 100 for low bandwidth communications (e.g., voice calls) associated with an originating user device (e.g., originator 120) facilitated by the whisper engine (e.g., whisper engine 106). Example computing environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. For example, other embodiments of example computing environment 100 may have additional or different types of originator and terminator user devices, more than one artificial intelligence engines, etc.

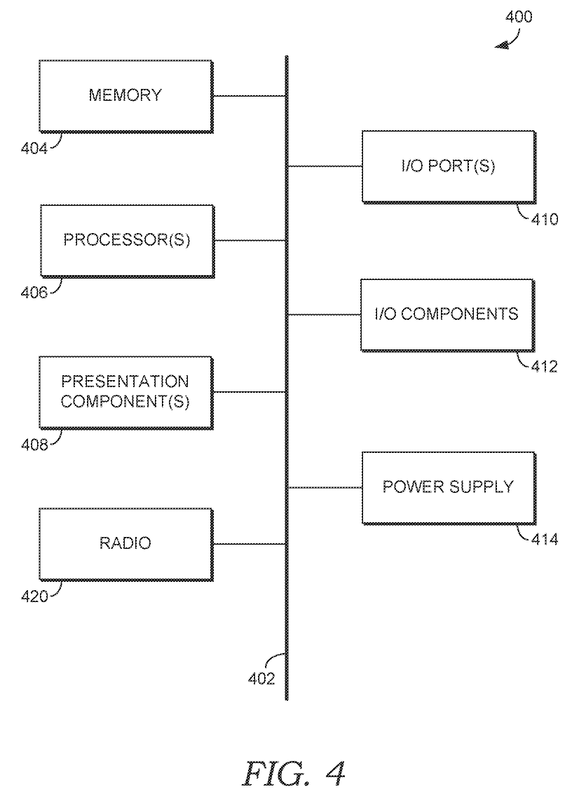

In embodiments, the terminator 102 and originator 120 may be user devices. A user device may be a device that has the capability of transmitting or receiving one or more signals (e.g., over the non-terrestrial network, over the terrestrial network). In some embodiments, a “user device” may be referred to as a “computing device,” “mobile device,” “user equipment (UE),” “wireless communication device,” a “server,” etc. A user device, in some implementations, may take on a variety of forms, such as a PC, a laptop computer, a tablet, a mobile phone, a PDA, a server, an internet-of-things device, a wireless local loop station, an Internet of Things (IoT) device, a machine type communication device, an evolved or enhanced machine type communication device, or any other device that is capable of communicating with a network node (e.g., a server, gNodeB, etc.). A user device may be, in an embodiment, user device 400 described herein with respect to FIG. 4. The originator 120 may be connected with a low-bandwidth link. The REST 112 and text path 118B each correspond to the low bandwidth link (e.g., satellite link having bandwidth below a threshold). The terminator 102 may be connected to a terrestrial network 104.

The whisper engine 106 may be utilizing or communicatively coupled with a non-terrestrial network (e.g., a 3GPP non-terrestrial network), with part of a non-terrestrial network, with part of both a non-terrestrial and terrestrial network, etc. For example, the non-terrestrial network may be connecting one or more gateways (e.g., a ground station comprising one or more devices or a system of components configured to provide an interface between a terrestrial network and the non-terrestrial network) to other network(s). In embodiments, the whisper engine 106 determines the originator 120 is connected with a low bandwidth link. In some embodiments, the whisper engine 106 is interfacing with the originator 120, which is connected with or utilizing one or more particular non-terrestrial beams (e.g., a satellite link). In embodiments, the satellite link may provide the originator 120 access to the non-terrestrial network via direct-to-cell. The whisper engine 106 may also interface with the terminator 102, through the terrestrial network 104 to which the terminator 102 is connected to.

With reference to the originator 120, the originator 120 may transmit a connection request to establish a connection with a non-terrestrial node (e.g., a low-bandwidth satellite link with a geostationary orbit (GEO) satellite, a low earth orbit (LEO) satellite, a medium earth orbit (MEO) satellite, a regenerative satellite, a space satellite, a balloon, a dirigible, an airplane, a drone (e.g., an unmanned aerial vehicle), a geosynchronous or geostationary earth orbit satellite, another type of satellite, another type of non-terrestrial node, etc., or one or more combinations thereof). The originator 120 may be communicatively coupled (e.g., through a web browser, by having the whisper application downloaded onto the originator 120, etc.) with the whisper engine 106.

Upon connecting with the low bandwidth link (e.g., ultra-low bandwidth satellite links or ELB-SC corresponding to a few hundred bits per second (bps) up to around 100 kilobits per second (kbps), a few kbps, 1 kbps, etc.), the originator 120 may transmit a request (e.g., a call request message) via the whisper application installed on the originator 120 to the whisper engine 106 over Representational State Transfer (REST) 112. In aspects, when the originator 120 wishes to make a call using low-bandwidth communication provided by the whisper engine 106, a user of the originator 120 may select an option on a whisper application interface of the originator 120 to initiate the low-bandwidth communication method. The request may include a uniform resource locator, header and body, etc. In other embodiments, the request to the whisper engine 106 may be transmitted in another lightweight transmission other than REST 112.

The request to the whisper engine 106 may include a session descriptor, such as a Session Description Protocol (SDP) information (e.g., a text-based format describing one or more capabilities and parameters of an audio or multimedia session, a text-based format describing one or more characteristics of the audio or multimedia session, such as a type of codec supported, a network address and satellite link used for communication, other session-related information, etc.). The SDP information may be located in one of a header, trailer, and/or body of the request. The SDP information includes a service identifier, which may be “s=text session” when originating from the originator 120, indicating a text session. In embodiments, the SDP information includes an m=text line that indicates the whisper engine 106 is to exchange text media between the originator 120 and the whisper engine 106. As one example, the "m=text" line may read "m=text 49200 Real-time Transport Protocol (RTP)/Audio Video Profile (AVP) 98," which indicates a text stream on port 49200 using RTP/AVP payload type 98. In another example, the line may read "m=application 9 User Datagram Protocol (UDP)/Datagram Transport Layer Security (DTLS)/Stream Control Transmission Protocol (SCTP) Web Real-Time Communication (webrtc)-data channel," indicating a SCTP-based data channel, enabling the transmission of text, over DTLS. The SDP information may include an “a=sendrecv” to indicate translation of text to synthetic audio (e.g., from the originator 120 to the terminator 102) and audio inputs into converted text (e.g., from the terminator 102 to the originator 120). Other session attributes may define characters per second, the port used for the data channel, or indicators that the endpoint can act as both the client and the server in a DTLS negotiation.

The whisper engine 106 may be a mobile over-the-top (OTT) communication platform having a real-time communication module and an enhanced media module. For example, the real-time communication module can enable real-time text or data communication from the originator 120 to the whisper engine 106 (e.g., via the whisper application, without an external plugin) to enable the exchange of text associated with the request transmitted over the REST 112. The real-time communication module may be Web Real-Time Communication module, another type of real-time communication module, or one or more combinations thereof.

The enhanced media module of the whisper engine 106 may have text-to-speech capabilities (e.g., via an AI engine 110) for transforming text into synthetic audio (e.g., for receipt by the terminator 102). For example, the whisper engine 106 may receive text by way of an interface on the originator 120 (e.g., whisper application interface), or the whisper engine 106 may receive a text, over REST 112, that was converted from audio inputs (e.g., input/output components described herein with respect to FIG. 4) received and converted by the whisper application installed onto the originator 120 or other software and/or hardware of the originator 120. The enhanced media module may facilitate, manage, modify, etc., or one or more combinations thereof, the flow of media from the originator 120 to the terminator 102. In embodiments, the enhanced media module may be a media proxy component, an intermediary server, part of a system between endpoints in a terrestrial network (e.g., terrestrial network 104) and non-terrestrial network, etc.

The real-time communication module and enhanced media module of the whisper engine 106 may receive the request from the originator 120 over REST 112 (e.g., an OTT request) and can translate the request into a Session Initiation Protocol (SIP) request for the terrestrial network 104 (e.g., a telephony network). During the translation, the whisper engine 106 updates the session descriptor, such as SDP information, to modify m=text with m=audio for audio routing by way of the terrestrial network to generate a new request. In embodiments, the whisper engine 106 updates the session descriptor based on determining the originator 120 is connected with a low bandwidth link. In one example, the line reads “m=audio 49170 RTP/AVP 0 8 18” indicating an audio stream on port 49170 using an RTP audio/video profile offering three codecs (0, 8, 18). Further, the whisper engine 106 may modify an application identifier, a service identifier (e.g., with “s=phone call”), internet protocol (IP) ports (e.g., a 16-bit number identifying an application or service with an IP address), port numbers, etc., or one or more combinations thereof, of the OTT request transmitted via the REST 112 to one or more identifiers associated with the enhanced media module of the whisper engine 106. For instance, the whisper engine 106 can change the IP ports of the request to media proxy IP ports. As such, a new request (e.g., a SIP INVITE request) is generated to include a modified SDP information showing m=audio and is routed by the whisper engine 106 to the terminator 102 through the terrestrial network 104 (e.g., through a cellular network or internet link). The SDP information of the initial request (e.g. communicated from the originator 120 to the whisper engine 106 via REST) may be retained for utilization by the whisper engine 106 to communicate a response to the initial request. In embodiments, a back-to-back user agent (B2BUA) may be employed to generate new requests and may generate a pair of re-INVITE requests for each of the originator 120 (e.g., having m=text) and the terminator 102 (e.g., having m=audio).

The terminator 102 receives the SIP INVITE request including the modified SDP information including m=audio over the terrestrial network 104, which may include the interface of the terminator 102 providing a call notification. Upon the terminator 102 answering the call associated with the SIP INVITE request including the modified SDP information including m=audio, the whisper engine 106 facilitates a two-way path (RTP audio path 118A between the terminator 102 and whisper engine 106 and text path 118B between the originator 120 and the whisper engine 106). In some aspects, the text path 118B between the whisper engine 106 and the originator 120 is a data channel, such as an OTT data channel. The RTP audio path 118A (e.g., between the enhanced media module of the whisper engine 106 and the terminator 102) is associated with m=audio for the terminator 102, and the text path 118B (e.g., between the enhanced media module of the whisper engine 106 and the originator 120) is associated with m=text for the originator 120. The text path 118B may correspond to the originator 120 using a data channel (e.g., OTT data channel) or another secure link.

In embodiments, the text path 118B utilizes one or more protocols (e.g., RTP, SCTP, DTLS, UDP) to communicate with the originator 120. In some embodiments, the text path 118B may leverage a line-oriented or message-queue protocol with built-in forward error correction (FEC). A protocol suitable for use with the present disclosure may support discrete message delivery, include sequence identifiers, and apply FEC techniques (e.g., Reed-Solomon or XOR-based redundancy) to enable recovery from packet loss without requiring retransmissions. In some embodiments, the text path 118B may utilize a lightweight transport protocol that avoids RTP overhead (e.g., modified RTP, custom protocol, consultative committee for space data systems (CCSDS), delay/disruption tolerant networking (DTN), Licklider transmission protocol (LTP), space communications protocol standards – transport protocol (SCPS-TP), modified UDP with FEC). A protocol suitable for use with the present disclosure may use minimal headers, coalesced message batching, or newline-delimited framing to maximize efficiency. In some embodiments, a custom UDP-based protocol or a message-queue protocol with static header templates may be employed to ensure that the majority of the available bandwidth is reserved for user content rather than protocol overhead. For example, a custom protocol with a 2-byte header and newline-delimited payloads may reduce overhead to under 10% of total bandwidth.

In aspects, the originator 120 receives text (e.g., text inputs, text locally converted from audio inputs) via the whisper application interface of the originator 120 and communicates the text to the whisper engine 106 with the SDP information including m=text, via text path 118B. In such aspects, the whisper engine 106 converts the text to synthetic audio and communicates the synthetic audio to the terminator 102 with modified SDP information including m=audio, via RTP audio path 118A. The terminator 102 may respond to the synthetic audio during the voice call with audio inputs (e.g., a user of the terminator 102 speaks into the terminator 102 in response). In aspects, the audio inputs from the terminator 102 are received by the whisper engine (e.g., via RTP audio path 118A) and the whisper engine 106 converts the audio inputs to converted text and communicates the converted text to the originator 120 with the modified SDP information including m=text, via text path 118B. In aspects, the whisper application of the originator 120 may locally convert the converted text to synthetic audio for presentation on the originator 120.

The AI engine 110 is communicatively coupled with the whisper engine 106. In other embodiments, the AI engine 110 may be part of the whisper engine 106. The AI engine 110 can convert text to speech (TTS) and speech to text (STT) (e.g., using natural language processing (NLP), machine learning, deep learning techniques, etc., or one or more combinations thereof). In embodiments, the AI engine 110 may employ an end-to-end speech recognition model, a recurrent neural network, a connectionist temporal classification model, automatic speech recognition using a transformer model, a self-supervised learning model, a deep neural network, a Gaussian mixture model, etc., or one or more combinations thereof, for STT. In embodiments, the AI engine 110 may employ a vocoder, a TTS end-to-end neural network, a non-autoregressive model, a transformer model, a deep generative model, a convolutional neural network, a generative adversarial network, a cloud-based TTS model, a wave net architecture, etc., or one or more combinations there, for TTS. In some embodiments, the AI engine may employ a single model or a combination of models for both TTS and STT during the two-way path. In aspects, the AI engine converts the text into synthetic audio reflecting a voice signature of the user of the originator 120.

From the terminator 102, the whisper engine 106 receives and captures audio inputs over the RTP audio path 118A, and the whisper engine 106 utilizes the AI engine 110 for STT and transmits the converted text to the originator 120 over the text path 118B by way of a low bandwidth transmission. From the originator 120, the whisper engine 106 receives and captures text (e.g., text inputs or locally converted text from audio inputs) over the text path 118B by way of the low bandwidth transmission (e.g., satellite link), and the whisper engine 106 utilizes the AI engine 110 for TTS and transmits the synthetic audio to the terminator 102 over the RTP audio path 118A. Because the originator 120 is communicating by way of the low bandwidth transmission (e.g., ultra-low bandwidth satellite links or ELB-SC, corresponding to a few hundred bits per second (bps) up to around 100 kilobits per second (kbps), a few kbps, 1 kbps, etc.), the originator 120 may receive either text or audio, from inputs provided by a user of the originator 120, and, in aspects, may convert the audio to text for transmission to the whisper engine 106 (e.g., by the whisper application, by other software and/or hardware of the originator 120). The originator 120 may receive converted text over the text path 118B from the whisper engine (e.g., corresponding to the audio inputs originating from the terminator 102) and locally convert the text to audio by way of the whisper application and/or by the hardware or software (e.g., a TTS module) of the originator 120. In embodiments, throughout the call, the originator 120 may use text-based communication via OTT (e.g., via data channel, via RTP), while the terminator 102 utilizes audio via RTP. In embodiments, once the terminator 102 or the originator 120 ends the call, the whisper engine 106 may release a call release procedure (e.g., SIP session termination and closure of the OTT data channel and/or RTP media path(s)).

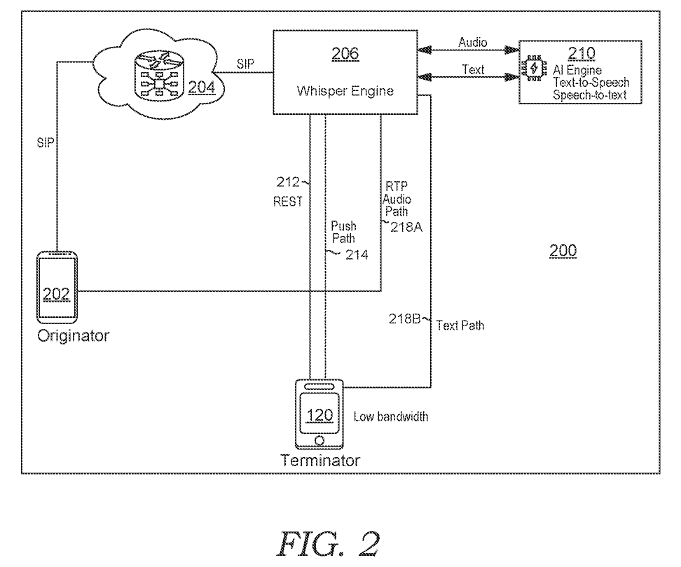

FIG. 2 includes an example computing environment 200 for low bandwidth communications (e.g., voice calls) associated with a terminating user device (e.g., terminator 220) facilitated by the whisper engine (e.g., whisper engine 206, the whisper engine 106 of FIG. 1) and may incorporate any one or more aspects described with respect to FIG. 1. Example computing environment 200 is but one example of a suitable environment for the technology and techniques disclosed herein, and is not intended to suggest any limitation as to the scope of use or functionality of the invention. Neither should the environment 200 be interpreted as having any dependency or requirement relating to any one or combination of components illustrated. For example, other embodiments of example computing environment 100 may have additional or different types of originator and terminator user devices, more than one artificial intelligence engine, etc.

In embodiments, the originator 202 and terminator 220 may be user devices. The terminator 220 is connected with a low bandwidth link (e.g., satellite link), and the whisper engine 206 may determine the terminator 220 is connected with the low bandwidth link. The REST 212, push path 214, and text path 218B each correspond to the low bandwidth link (e.g., satellite link having bandwidth below a threshold). The originator 202 initiates a voice call (e.g., using the terrestrial network 204). The originator 202 transmits a SIP INVITE request having SDP information indicating m=audio to the whisper engine 206 (e.g., the whisper engine 106 of FIG. 1 being an OTT communication platform having a real-time communication module and an enhanced media module). The whisper engine 206 receives the SIP INVITE request having the SDP information indicating m=audio, and the whisper engine 206 updates the SDP information (e.g., by appending or modifying the m=audio to m=text) to generate a new request for a voice call. For example, the whisper engine 206 modifies the IP ports of the originator 202 and updates the SDP information to include IP ports of the enhanced media module of the whisper engine 206. In embodiments, the whisper engine 206 updates the session descriptor based on the terminator 220 being connected with a low bandwidth link. The whisper engine 206 transmits the new request having the modified SDP information including the m=text (e.g., transmits it OTT) to the terminator 220 over the low bandwidth link (e.g., over REST 212 or push path 214). Based on receiving the new request including the modified SDP information including the m=text, the terminator 220 notifies a user (e.g., via a whisper application interface of the terminator 220) of an incoming call (e.g., by way of the whisper application downloaded on the terminator 220). In embodiments, the push notification received by the terminator 220 over the push path 214 is a short messaging service (SMS) notification, such as a SMS-over-satellite notification, or a polling REST notification (e.g., a response to periodic HTTP requests from the terminator 220 to check for pending voice call requests).

Upon acceptance of the call by the terminator 220, the whisper engine 206 initiates a voice call and establishes the two-way path (RTP audio path 218A between the originator 202 and whisper engine 206 via an RTP media path) (e.g., text path 218B between the terminator 220 and the whisper engine 206 via an RTP text path or data channel). The RTP audio path 218A (e.g., between the enhanced media module of the whisper engine 206 and the originator 202) is associated with m=audio for the originator 202, and the text path 218B (e.g., between the enhanced media module of the whisper engine 206 and the terminator 220) is associated with m=text for the terminator 220. The text path 218B may correspond to the terminator 220 using a data channel or another secure link.

In aspects, the terminator 220 receives converted text (e.g., via text path 218B) converted by the whisper engine 206 (e.g., STT by the AI engine 210 having any one or more aspects as the AI engine 110 of FIG. 1) from audio inputs received by the whisper engine 206 from the originator 202 (e.g., via RTP audio path 218A). A user of the terminator 220 may respond with audio inputs, which may be locally converted to text, or with text inputs, which are communicated to the whisper engine 206 (e.g., via text path 218B). The whisper engine 206 may then convert the text to synthetic audio (e.g., TTS by the AI engine 210), which is communicated to the originator 202 (e.g., via RTP audio path 118A). In aspects, the synthetic audio reflects a voice signature of the terminator 220. The originator 202 may provide audio inputs in response, which are received by the whisper engine 206 and converted to converted text to be communicated to the terminator 220 (e.g., via text path 218B).

From the originator 202, the whisper engine 206 receives and captures audio over the RTP audio path 218A (e.g., via the RTP path between the originator 202 and the whisper engine 206), and the whisper engine 206 utilizes the AI engine 210 for STT and transmits the converted text to the terminator 220 over the text path 218B by way of a low bandwidth transmission (e.g., via an RTP path or data channel between the whisper engine 206 and the terminator 220). From the terminator 220, the whisper engine 206 receives and captures text over the text path 218B by way of the low bandwidth transmission (e.g., satellite link), and the whisper engine 206 utilizes the AI engine 210 for TTS and transmits the synthetic audio to the originator 202 over the RTP audio path 218A (terrestrial network 204). Because the terminator 220 is communicating by way of the low bandwidth transmission (e.g., ultra-low bandwidth satellite links or ELB-SC, corresponding to a few hundred bits per second (bps) up to around 100 kilobits per second (kbps), a few kbps, 1 kbps, etc.), the terminator 220 may receive (e.g., through a whisper application interface) either text inputs or audio inputs (e.g., from the user of the terminator 220) and, in aspects, locally convert the audio inputs to text for transmission to the whisper engine 206. In aspects, the terminator 220 may receive converted text over the text path 218B from the whisper engine 206 (e.g., originating from the originator 202) and locally convert the converted text to synthetic audio by way of the whisper application and/or software or hardware installed on the terminator 220. In embodiments, throughout the two-way path call, the terminator 220 may use text-based communication via OTT, while the originator 202 utilizes voice call (e.g., through terrestrial network 204). In embodiments, once the originator 202 or the terminator 220 ends the call, the whisper engine 206 may release a call release procedure (e.g., SIP session termination and closure of the OTT data channel and/or RTP media path(s)).

### Example Flowchart

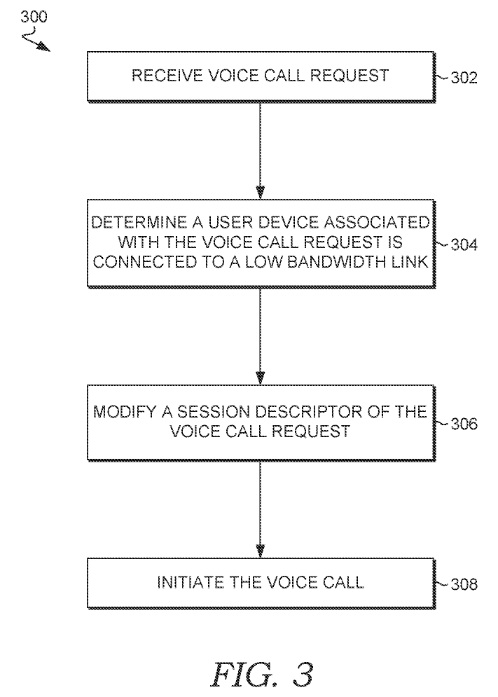

Having described the example embodiments discussed above, an example flowchart 300 is described below with respect to FIG. 3, which may incorporate any one or more aspects described with respect to FIGS. 1-2. Example flowchart 300 begins at step 302 with receiving a voice call request. For example, the whisper engine 106 of FIG. 1 or the whisper engine 206 of FIG. 2 can receive a request for a voice call between a first user device and a second user device. The request may be received, for example, from an originator user device, such as the originator 120 of FIG. 1 (e.g., over the terrestrial network) or the originator 202 of FIG. 2 (e.g., over the low bandwidth link).

The request and the voice call may correspond to the first user device being connected with a low bandwidth link (e.g., ultra-low bandwidth satellite links or ELB-SC corresponding to a few hundred bits per second (bps) up to around 100 kilobits per second (kbps), a few kbps, 1 kbps, etc.) and that the second user device being connected with a terrestrial network. The request may include a session descriptor (e.g., session description protocol (SDP) information within the request). In some embodiments, the request includes a m=text line (indicating media type text), such as where the originator user device is the originator 120. In some embodiments, the request includes a m=audio line (indicating media type audio), such as where the originator user device is the originator 202.

The request may be received by the whisper engine 106 of FIG. 1 or the whisper engine 206 of FIG. 2. In some embodiments, the request may be received via REST (e.g., REST112 of FIG. 1) from the first user device (e.g., where the first user device is the originator 120 of FIG. 1 and is communicating over the low bandwidth link). In some embodiments, the request may be received in another lightweight transmission other than REST. In some embodiments, the request may be received via SIP and communicated via the terrestrial network by the second user device (e.g., where the second user device is the originator 202 of FIG. 2 and is communicating over the terrestrial network).

In some embodiments, the request is an HTTP request. In some embodiments, the request includes a uniform resource locator, header, body, etc., or one or more combinations thereof. In some embodiments, the request may include a text-based format describing one or more capabilities and parameters of the voice call, a text-based format describing one or more characteristics of the voice call (e.g., a type of codec supported, a network address and satellite link used for communication, other session-related information, etc.), etc., or one or more combinations thereof.

At step 304, a determination is made that one of the user devices associated with the voice call is connected to a low bandwidth link (e.g., determined by the whisper engine 106 of FIG. 1 or the whisper engine 206 of FIG. 2). In some embodiments, it is determined that the first user device (e.g., originator 120 of FIG. 1, terminator 220 of FIG. 2) is connected with the low bandwidth satellite link and that the second user device (e.g., terminator 102 of FIG. 1, originator 202 of FIG. 2) is connected with a terrestrial network. In embodiments, the whisper engine 106 of FIG. 1 or the whisper engine 206 of FIG. 2 may determine these connections based on prior communications with these user devices. In embodiments, the whisper engine 106 of FIG. 1 or the whisper engine 206 of FIG. 2 may determine these connections based on communications with the terrestrial network and a non-terrestrial network.

At step 306, a session descriptor (e.g., SDP information) is modified. In some embodiments, the session description protocol (SDP) information of the request, which was received from the first user device over the low bandwidth satellite link, may be modified from media type text to media type audio to generate a new request. In embodiments, the session descriptor is modified (e.g., by whisper engine 106) so that the session descriptor (e.g., SDP information) includes m=audio for audio routing by way of the terrestrial network. In embodiments, the whisper engine 106 may modify an application identifier, a service identifier, IP, IP ports, etc., or one or more combinations thereof, of the session descriptor (e.g., within an OTT request received over the REST 112), such that the modified session descriptor is associated with the enhanced media module of the whisper engine 106. In embodiments, the whisper engine 106 may modify an IP port of the request to a media proxy IP port associated with the enhanced media module of the whisper engine 106. In some embodiments, the modified session descriptor is included in a new SIP INVITE that was generated to include modified SDP information showing m=audio (media type audio) from the request received by the whisper engine 106.

In embodiments, the session descriptor is modified (e.g., by whisper engine 206) so that the session descriptor (e.g., SDP information) includes m=text for text routing through the low bandwidth link. In some embodiments, the session description protocol (SDP) information within the request, received from the second user device over a terrestrial network, is modified from media type audio to media type text. The modified session descriptor is transmitted to the terminator device by way of a new request. In embodiments, the session descriptor is modified based on the whisper engine 206 determining the user device (e.g., the first user device, the second user device) is connected with a low bandwidth link. In embodiments, the whisper engine 206 may modify an application identifier, a service identifier, IP, IP ports, etc., or one or more combinations thereof, of the session descriptor (e.g., within a request received over the terrestrial network), such that the modified session descriptor is associated with the enhanced media module of the whisper engine 206. As an example, the whisper engine 206 may modify an IP port of the request to a media proxy IP port associated with the enhanced media module of the whisper engine 206. In some embodiments, the modified session descriptor is included in a new request that was generated to include modified SDP information showing m=text (media type text).

At step 308, the voice call is initiated. In some embodiments, the voice call between the first user device connected with the low bandwidth link and the second user device is initiated based on transmitting the modified session descriptor. In some embodiments, initiating the voice call between the first user device connected with the low bandwidth satellite link and the second user device is based on initiating a two-way path, a first path of the two-way path being text-based with the first user device and a second path of the two-way path being audio-based with the second user device. In some embodiments, the initiating of the voice call is based on transmitting the modified SDP information including the media type text to the first user device over the low bandwidth link. In some embodiments, the initiating of the voice call is based on transmitting the modified SDP information including the media type audio to the second user device over a terrestrial network. In some embodiments, the initiating of the voice call is based on initiating a two-way Real-time Transport Protocol (RTP) path, a first RTP path of the two-way RTP path being RTP text with the first user device and a second RTP path of the two-way RTP path being RTP audio with the second user device. In other embodiments, the initiating of the voice call is based on initiating a two-way path, a first path being a data channel (e.g., WebRTC data channel) with the first user device and a second path being an RTP audio path with the second user device. In some embodiments, the initiating of the voice call is based on transmitting the modified SDP information including the media type audio to the second user device over a terrestrial network.

### Example User Device

Referring now to FIG. 4, a diagram is depicted of an example user device suitable for use in implementations of the present disclosure. In particular, the example environment is shown and designated generally as user device 400. User device 400 is but one example of a suitable computing environment and is not intended to suggest any limitation as to the scope of use or functionality of the invention. Neither should user device 400 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a network.

With continued reference to FIG. 4, user device 400 includes bus 402 that directly or indirectly couples the following devices: memory 404, one or more processors 406, one or more presentation components 408 (e.g., a whisper application interface), a power supply 414, and one or more radios 420. In embodiments, the memory 404 may include whisper application operating instructions (e.g., instructions suitable to operate the whisper application installed on the user device 400), which may be executed by the processor(s) 406.

Although the components of FIG. 4 are shown with lines for the sake of clarity, in reality, delineating various components is not so clear, and metaphorically, the lines would more accurately be grey and fuzzy. For example, one may consider a presentation component, such as a display device to be one of input/output components. As another example, processors, such as one or more processors 406, have memory. The present disclosure hereof recognizes that such is the nature of the art and reiterates that FIG. 4 is merely illustrative of an example computing environment for a user device that may be used in connection with one or more implementations of the present disclosure. Additionally, distinction is not made between such categories as “workstation,” “server,” “laptop,” “handheld device,” etc., as all are contemplated within the scope of FIG. 4 and refer to “computer” or “user device.” In yet another example, bus 402 may represent what may be one or more buses (such as an address bus, data bus, or combination thereof).

User device 400 typically includes a variety of computer-readable media. Computer-readable media may be any available media that may be accessed by user device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 404 includes computer-storage media in the form of volatile and/or nonvolatile memory. Memory 404 may be removable, non-removable, or a combination thereof. Examples of memory 404 may include solid-state memory, hard drives, optical-disc drives, etc., or one or more combinations thereof. In embodiments, the whisper application operating instructions which may be stored in memory 404, may be used by the one or more processors 406 to cause the one or more processors 406 to perform the whisper application operations. In embodiments, the whisper application operations may include receiving text inputs or audio inputs from a user of the user device 400. The whisper application operations may include local conversion of audio inputs using STT to generate text to be communicated to the whisper engine, such as the whisper engine 106 of FIG. 1 or the whisper engine 206 of FIG. 2. The whisper application operations may include communicating the text to the whisper application, and receiving text from the whisper application (e.g., originating from another user device participating in the voice call). The whisper application operations may include receiving converted text from another user device participating in the voice call. In such embodiments, the whisper application may use local conversion of the converted text to present synthetic audio on the user device 400.

User device 400 also includes one or more processors 406 that read data from various entities, such as bus 402, memory 404, or input/output components of the user device 400. Examples of one or more processors 406 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors or other suitable hardware configured to perform operations, such as the whisper application operations (e.g., received from the whisper engine 106 of FIG. 1 or the whisper engine 206 of FIG. 2).

One or more presentation components 408 may present (e.g., to a person or other device) information (e.g., text) to a user of the user device 400. Examples of the one or more presentation components 408 may include a display device, speaker, printing component, vibrating component, etc. Examples of the whisper application interface may present an alarm or notification that another user wishes to have a voice call with the user of the user device 400, present audio or text provided over one of the paths of the two-way path, etc. In aspects, a push notification (e.g., received via push path 214 of FIG. 2) may be presented on the whisper application interface of the user device 400 to indicate a voice call is being established via the whisper engine 106 or the whisper engine 206 (e.g., where the user device 400 is the terminator 220).

In some embodiments, the user device 400 includes input/output ports that allow user device 400 to be logically coupled to input/output components or other devices. In some embodiments, only a portion of a plurality of input/output components may be built into user device 400. Illustrative input/output components may include a microphone, joystick, game pad, satellite dish, scanner, printer, wireless device, etc., or one or more combinations thereof. In some embodiments, the one or more presentation components may provide an indication (e.g., via the display or vibrating component) that the user device 400 is performing one or more of the whisper application operations.

In some embodiments, the user device 400 may have one or more radios, such as the radio 420, that facilitate communication with a wireless telecommunications network. Illustrative wireless telecommunications technologies may include CDMA, GPRS, TDMA, GSM, and the like. This radio 420 might additionally or alternatively facilitate other types of wireless communications including Wi-Fi, WiMAX, LTE, or other VoIP communications. As can be appreciated, in various embodiments, the radio 420 may be configured to support multiple technologies and/or multiple radios 420 may be utilized to support multiple technologies. By way of example, the radio 420 may be configured to support an 8-element MIMO antenna configuration for 5G smartphones or another number of elements for various antenna configurations for other generation smartphones or user devices for implementing various operations.

A wireless telecommunications network might include an array of devices, which are not shown so as to not obscure more relevant aspects of the invention. Components, such as a base station, a communications tower, one or more satellites, other access points (as well as other network components), or one or more combinations thereof, may provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A method comprising:
receiving a request for a voice call between a first user device and a second user device;
determining that the first user device is connected with a low bandwidth link;
modifying a session descriptor of the request based on determining that the first user device is connected with the low bandwidth link to generate a modified session descriptor; and
initiating the voice call between the first user device connected with the low bandwidth link and the second user device based on transmitting the modified session descriptor.

2. The method according to claim 1, wherein the session descriptor is session description protocol (SDP) information, the method further comprising:
receiving the SDP information from the second user device, connected with a terrestrial network, the SDP including media type audio;
modifying the media type audio to media type text to generate modified SDP information; and
initiating the voice call based on transmitting the modified SDP information including the media type text to the first user device over the low bandwidth link.

3. The method according to claim 1, wherein the session descriptor is session description protocol (SDP) information, the method further comprising:
receiving the SDP information from the first user device, over the low bandwidth link, the SDP including media type text;
modifying the media type text to media type audio to generate modified SDP information; and
initiating the voice call based on transmitting the modified SDP information including the media type audio to the second user device over a terrestrial network.

4. The method according to claim 1, further comprising initiating the voice call by initiating a two-way Real-time Transport Protocol (RTP) path, a first RTP path of the two-way RTP path being an RTP text path with the first user device and a second RTP path of the two-way RTP path being an RTP audio path with the second user device.

5. The method according to claim 4, further comprising:
receiving text from the first user device over the low bandwidth link via the RTP text path;
utilizing an artificial intelligence model to transform the text to synthetic audio; and
transmitting the synthetic audio, over a terrestrial network via the RTP audio path, to the second user device.

6. The method according to claim 4, further comprising:
receiving, from the second user device over a terrestrial network via the RTP audio path, audio inputs;
utilizing an artificial intelligence model to transform the audio inputs to converted text; and
transmitting the converted text, over the low bandwidth link via the RTP text path, to the first user device.

7. The method according to claim 6, further comprising causing the first user device to generate audio from the converted text.

8. The method according to claim 4, further comprising:
receiving the session descriptor, which is session description protocol (SDP) information including media type text, from the first user device transmitting the SDP information using Representational State Transfer (REST) over the low bandwidth link;
modifying the media type text to media type audio to generate modified SDP information; and
initiating the two-way RTP path based on transmitting the modified SDP information including the media type audio to the second user device over a terrestrial network.

9. One or more computer storage media having computer-executable instructions embodied thereon, that when executed by at least one processor, cause the at least one processor to perform a method comprising:
receiving a request for a voice call between a first user device and a second user device;
determining that the first user device is connected with a low bandwidth satellite link; and
initiating the voice call between the first user device connected with the low bandwidth satellite link and the second user device by initiating a two-way path, a first path of the two-way path being text-based with the first user device and a second path of the two-way path being audio-based with the second user device.

10. The media of claim 9, the method further comprising:
modifying session description protocol (SDP) information within the request, received from the first user device over the low bandwidth satellite link, from media type text to media type audio to generate modified SDP information; and
initiating the voice call based on transmitting the modified SDP information including the media type audio to the second user device over a terrestrial network.

11. The media of claim 9, the method further comprising:
modifying session description protocol (SDP) information of the request, received from the second user device over a terrestrial network, from media type audio to media type text to generate modified SDP information; and
initiating the voice call based on transmitting the modified SDP information including the media type text to the first user device over the low bandwidth satellite link.

12. The media of claim 9, the method further comprising:
receiving text from the first user device over the low bandwidth satellite link via the first path;
utilizing an artificial intelligence model to transform the text to synthetic audio; and
transmitting the synthetic audio, over a terrestrial network via the second path, to the second user device.

13. The media of claim 9, the method further comprising:
receiving, from the second user device over a terrestrial network via the second path, audio inputs;
utilizing an artificial intelligence model to transform the audio inputs to converted text; and
transmitting the converted text, over the low bandwidth satellite link via the first path, to the first user device.

14. The media of claim 13, the method further comprising causing the first user device to generate audio from the converted text.

15. A system comprising at least one processor and computer storage media having computer-executable instructions embodied thereon, that when executed by the at least one processor, cause the at least one processor to:
receive a request for a voice call between a first user device and a second user device;
determine that the first user device is connected with a low bandwidth satellite link and that the second user device is connected with a terrestrial network;
modify a session descriptor of the request to generate a modified session descriptor based on determining that the first user device is connected with the low bandwidth satellite link and that the second user device is connected with the terrestrial network;
transmit the modified session descriptor; and
initiate the voice call between the first user device and the second user device based on transmitting the modified session descriptor.

16. The system according to claim 15, the at least one processor further caused to:
receive the session descriptor, which is session description protocol (SDP) information including media type text, from the first user device via Representational State Transfer (REST) over the low bandwidth satellite link;
modify the session descriptor from media type text to media type audio to generate a modified session descriptor; and
initiate the voice call based on transmitting the modified session descriptor including the media type audio to the second user device over the terrestrial network.

17. The system according to claim 15, the at least one processor further caused to:
receive the session descriptor, which is session description protocol (SDP) information including media type audio, from the second user device;
modify the session descriptor from media type audio to media type text to generate a modified session descriptor; and
initiate the voice call based on transmitting the modified session descriptor including the media type text to the first user device over the low bandwidth satellite link.

18. The system according to claim 15, the at least one processor further caused to initiate the voice call by initiating a two-way real-time path, a first path of the two-way real-time path being text-based with the first user device and a second path of the two-way real-time path being audio-based with the second user device.

19. The system according to claim 18, the at least one processor further caused to:
receive text from the first user device over the low bandwidth satellite link via the first path;
utilize an artificial intelligence model to transform the text to synthetic audio; and
transmit the synthetic audio, over the terrestrial network via the second path, to the second user device.

20. The system according to claim 18, the at least one processor further caused to:
receive, from the second user device over the terrestrial network via the second path, audio inputs;
utilize an artificial intelligence model to transform the audio inputs to converted text; and
transmit the converted text, over the low bandwidth satellite link via the first path, to the first user device.
